(19) United States
(12) Patent Application Publication
(10) Pub. No.: US 2008/0033609 A1
(43) Pub. Date: Feb. 7, 2008

(54) Automotive diagnostic and tuning system

(76) Inventor: Ramin Razavi, Laguna Niguel, CA (US)

Correspondence Address: STETINA BRUNDA GARRED & BRUCKER, 75 ENTERPRISE, SUITE 250, ALISO VIEJO, CA, 92656, US

(21) Appl. No.: 11/499,066

(22) Filed: Aug. 4, 2006

(51) Int. Cl. G01M 17/00

(52) U.S. Cl. 701/33; 701/29

(57) ABSTRACT

A stand-alone, computer-based automotive diagnostic and tuning system to be directly plugged into the on-board diagnostic port of the vehicle and powered by the vehicle without the need of any external wires and batteries or other power sources. The system has a first interface for connecting an on-board diagnostic interface of a vehicle, a second interface for connecting to a removable memory device, and a firmware executed to retrieve data of the vehicle through the first interface and to record the data into the removable memory device. The first interface is operative to communicate with the on-board diagnostic interface supported by at least one of pulse width modulation protocol, VPW protocol, ISO9141-2 protocol, ISO 14230 KWP2000 protocol, and ISO 15765 CAN protocol, and the second interface includes a USB interface.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates in general to an automotive diagnostic and tuning system, and more particular, to an on-board diagnostic (OBD) automotive diagnostic and tuning system.

OBD is a standard interface to the on-board computer of a vehicle to allow for readout of diagnostic trouble codes (DTCs) that have been generated by the on-board computer, as well as real-time data from the sensors connected to the on-board computer. The OBD-II interface additionally provides a means to clear the DTC list once maintenance has been completed. Many individual manufactures have been known to enhance the second generation of the OBD (OBD-II) code with a host of proprietary DTCs. The OBD-II specification provides for a standard hardware interface—the female 16-pin (2×8) J1962 connector. The OBD-II connector is located on the driver's side of the passenger compartment near the center console. Defined by the Society Automotive of Engineering (SAE), the pinouts 2, 4-7, 10, and 14-16 of the connector are Bus positive Line of SAE-J1850, Chassis ground, Signal Ground, CAN_H line of ISO 15765-4, K line of ISO 9141-2 and ISO 14230-4, Bus negative Line of SAE-J1850, CAN_L of ISO 15765-4, L line of ISO 9141-2 and ISO 14230-4, and Permanent positive voltage, respectively; and assignment of unspecified pins is left to the vehicle manufacturer's discretion.

Currently, several protocols, including SAEJ1850 PWM (pulse width modulation), SAEJ1850 VPW (variable pulse width), ISO9141-2, ISO 14230 KWP2000 (Keyword Protocol 2000), and ISO 15765 CAN (controller area network), are in use with the OBD-II interface, and it is possible to determine the specific protocol in use based on which pins are present on the J1962 connector, the high voltage and the message length restriction. OBD-II provides access to numerous data from the electronic controller unit (ECU) and offers a valuable source of information when troubleshooting problems inside a vehicle. The SAE J1979 standard defines a method for requesting various diagnostic data and a list of standard parameters that might be available from the ECU. The various parameters that are available are addressed by “parameter identification numbers” or PIDs which are defined in J1979. According to the OBD-II standard, requests to the ECU of a vehicle via the OBD-II port are made up of two bytes (excluding header and CRC bytes). The first byte determines the desired mode of operation, and the second byte is the requested parameter identification (PID) number. The ECU will respond with a two byte acknowledgement and possibly some number of data bytes. There are nine modes of operation described in the OBD-II standard, including “show current data”, “show freeze frame data”, “show stored trouble codes”, “clear trouble codes and stored values”, “test results, oxygen sensors”, “test results, non-continuosly monitored”, “show pending trouble codes”, “special control mode”, and “request vehicle information”. Vehicle manufactures are not required to support all modes, and they are allowed to include custom modes above number 9.

The scanning or data acquisition tools can be categorized into stand-alone type and computer-based type, depending on whether they require a computer to operate. The stand-alone type provides portability but, unfortunately, is often limited to specific supported protocol and the memory capacity. The computer-based type is typically implemented by software installed in the computer which connects to the OBD port of the vehicle to be disgnosted directly. The computer-based type data acquisition tools are advantageously of relatively low cost with vircually unlimited memory capacity, but lack portability. Accordingly, there is a need in the art for an improved automotive diagnostic and tuning system that overcomes these disadvantages.

### BRIEF SUMMARY

A stand-alone, computer-based automotive diagnostic and tuning system that addresses and alleviates the aforementioned deficiencies in the art is provided. The automotive diagnostic and tuning system can be connected to an on-board diagnostic port via a cable or directly plugged in the on-board diagnostic port of the vehicle and powered by the vehicle without the need of additional or external wires and batteries or power sources. The system includes a first interface for communicating the on-board diagnostic port, through which data can be retrieved from the electronic control unit of the vehicle, a second interface for communicating to a removable memory device to which the data of the vehicle is stored for further analysis, and a firmware executed to perform the data retrieval, transfer and recording. Preferably, the first interface is operative to communicate with the on-board diagnostic interface supported by at least one of pulse width modulation protocol, VPW protocol, ISO9141-2 protocol, ISO 14230 KWP2000 protocol, and ISO 15765 CAN protocol. The second interface includes a USB interface, which, in one embodiment, is further divided into a host USB port and a slave USB port.

The automotive diagnostic and tuning system may further comprise a third interface for connecting a computer. The third interface includes a USB interface or a serial bus, for example. The firmware includes a Flash ROM and a software pre-stored in the Flash ROM. When the computer is connected to the system, the software can be updated or reprogrammed by the computer, and the system can enter a maintenance mode. Alternatively, when a removable memory device that contains a configuration file is connected to the second interface, the software may also be updated or reprogrammed. Preferably, the software includes a proprietary application software (i.e., that does not fall into public domain) and a system software makes use of at least one public domain components covered by General Public License. The system software provides a plurality of drivers to interface the vehicle, the computer and the removable memory device and a plurality of internal devices. The Flash ROM further includes a configuration table pre-stored therein to initialize the system upon booting.

In one embodiment, the system further comprises a plurality of light-emitting diodes, with each being operative to emit light in a plurality of patterns. The combinations of the light patterns emitted by the light-emitting diodes are predefined to indicate various operation conditions. The system may further comprise at least one switch operative to generate interrupt during operation. For example, when the switch is pressed and held for a specific period of time, such as 3 seconds, the system may be forced to enter the logging mode from the normal operation mode. When the switch is pressed and held for a period of time, for example over 3 seconds, the open files may be forced to open/close, and new files may be generated.

In another embodiment, a programmable stand-alone type of automotive diagnostic and tuning system is provided. The system includes a first connection port operative to plug in an on-board diagnostic device of a vehicle and delivering power from the vehicle, a second connection port allowing a removable memory device to plug in, a set of memory devices pre-storing a software controlling operation of the system, and a set of light-emitting diodes operative to generate a plurality of patterns to indicate a plurality of different operation conditions. The software pre-stored in the set of memory devices is updated when the removable memory device plugged in the second connection port contains a configuration file. The second connection port includes a USB port, which may be divided into a host USB port and a slave USB port. The system further comprises a switch operative to switch operation into a logging mode while being pressed. Preferably, the further comprises a third connection port, such as a USB port or a serial port, for example, for connecting with a computer to allow the system to enter the maintenance mode.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows the interfaces provided by an automotive data acquisition system;

FIG. 2 shows various patterns of light emitted by the LEDs;

FIG. 3 is a block diagram showing the hardware structure of the automotive data acquisition system;

FIG. 4 is a block diagram showing the main components of the application software and system software of the automotive data acquisition system;

FIG. 5 shows the layout and data allocation of the Flash ROM, SRAM and Flash RAM;

FIG. 6 is a flow chart showing the process of a normal operation mode undertaken by the automotive data acquisition system;

FIG. 7 shows the process flow of the logging mode undertaken by the automotive data acquisition system; and

FIG. 8 shows the process flow of the power saving mode.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the Figures, and initially to FIG. 1, there is shown an automotive data acquisition system 10 destined to the automotive industry for collecting data at predetermined intervals from a vehicle 12 and storing the collected data on a removable medium 14 for later analysis. As illustrated, the data acquisition system 10 is connected to a second generation of on-board diagnostic (OBD-II) port built in a vehicle through a standard interface 101 such as a CAN, J1708, J1587, J1939, J1850, ISO9141, or KWP2000 interface for collecting data of the vehicle. Although the application of the second generation of the on-board diagnostic (OBD-II) is illustrated in this embodiment, it will be appreciated that the automotive data acquisition system as provided can also be applied or modified to applied to other or future generation of on-board diagnostic system without exceeding the scope of the current invention.

The data acquisition system 10 further includes another interface 102 connecting the removable memory device 14, so as to allow the data collected from the vehicle to be transferred to the removable memory device 14. Although various types of removable memory devices can be used for the data storage, in this embodiment, a USB Flash memory stick is preferably used and connected to the data acquisition system 10 via a USB port 102. For security reasons, only the USB Flash memory with a predetermined product ID or vendor ID is used to prevent the data from being tampered when the memory device 14 is disconnected from the data acquisition system 10. Preferably, the removable memory device 14 includes a pre-stored application software allowing the user to access the recorded data, such as the graph, gauge, sensor information in various ways when the removable memory device 14 is inserted in the computer 16 without the requirement of downloading any additional software to the computer. A serial line or another USB interface 103 may also be built in the data acquisition system 10 to connect a personal computer (PC) 16 so as to provide not only the device and application configuration and maintenance operations. While performing diagnostic of the vehicle 12, the direct connection to the computer 16 allows the diagnostic data to be displayed directly. In addition, the application provided by the removable memory device 14 may also be performed via the direct connection between the computer 16 and the data acquisition system 10. The data acquisition system 10 may further include an additional serial plug 106 used for input and output. As an output port, the data that is being recorded in the data acquisition system 10 can also be output through this serial plug 106. The additional serial plug 106 is preferably designed to output data to a GSM unit, which will transmit data via cell to an Internet service already in place, such that an individual can obtain the data in a remote location when the diagnostic is performed. Combined with a GPS unit, the individual can also obtain the location information of the vehicle 14 which is under the diagnostic process.

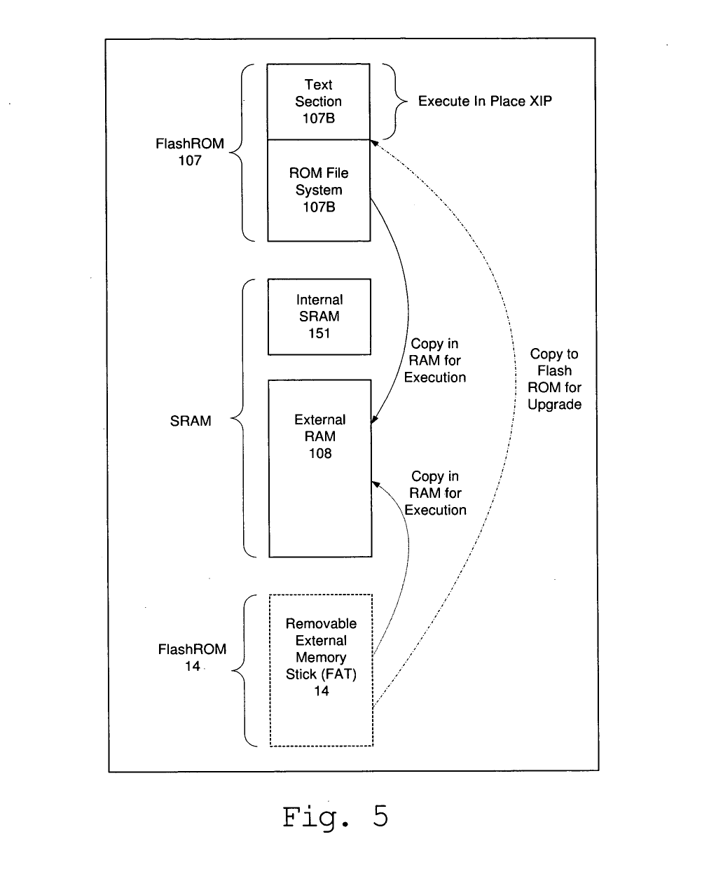

As shown FIG. 1, the data acquisition system 10 further comprises a buzzer 105 to alert the driver when various pre-set parameters, including vehicle speed, rpm, temperature, load percentage and voltage have reached limits and switches and LEDs 104 that are operative to serve as simple user interface allowing some simple device control in the field, respectively. The LEDs may display with different patterns to indicate different operation conditions of the data acquisition system 10. For example, as shown in FIG. 4, each LED may have four different light-emitting patterns, including off 0, slow flashing 1, fast flashing 2, and on 3, and the combination of the light-emitting patterns can be used to indicate a normal operation state, condition correctable by the user, an intermittent condition or a fatal failure for a specific operation. For example, the data acquisition system 10 as shown in FIG. 1 includes three LEDs denoted as RED, GRN1 and GRN2, and the combined light-emitting patterns of these three LEDs informs the user the current condition or state of the data acquisition system 10 as listed in Table I.

TABLE 1

| LED | Description | Level |
|---|---|---|
| 0 X 3 | Ready to sample data. The GRN2 LED may flash at a | N |
| | variable rate as data is actually sampled. | |
| 0 3 X | Writing data to the external media. The GRN1 LED may | N |
| | flash at a variable rate as data is actually written. | |
| 3 0 0 | ISD Failure CODE-CHK | F |
| 3 0 1 | ISD Failure SRAM-I | F |
| 3 1 0 | ISD Failure SRAM-X | F |
| 3 1 1 | ISD Failure CAN | F |
| 3 0 2 | ISD Failure USB | F |
| 3 2 0 | ISD Failure TIMER | F |
| 3 2 2 | ISD Failure CLOCK | F |
| 2 0 0 | Reserved | I |
| 2 0 1 | One corrupted configuration table. The other table is used. | I |
| 2 1 0 | Upgrading software | I |
| 1 0 0 | Removable memory stick is read only or not specially | U |
| | formatted. The device waits until a proper | |
| | memory stick is inserted. | |
| 1 0 1 | No memory stick. The device waits until a memory stick | U |
| | is inserted. | |
| 1 1 0 | No valid configuration. Device will be erased by pressing | U |
| | the switch for more than three seconds. | |
| 1 1 1 | System event log full of critical events and there is no room | U |
| | on the external memory stick to write the logs. No more | |
| | entries can be added. The system configuration Table is set | |
| | to stop operations until the table is cleared. Press the switch | |
| | to erase the log and continue operations. | |
| 1 0 2 | Watchdog alert. The system locked up and the | U |
| | configuration is set to wait for the switch to be pressed | |
| | to reset device. | |
| 1 2 0 | | U |
| 1 2 2 | | U |

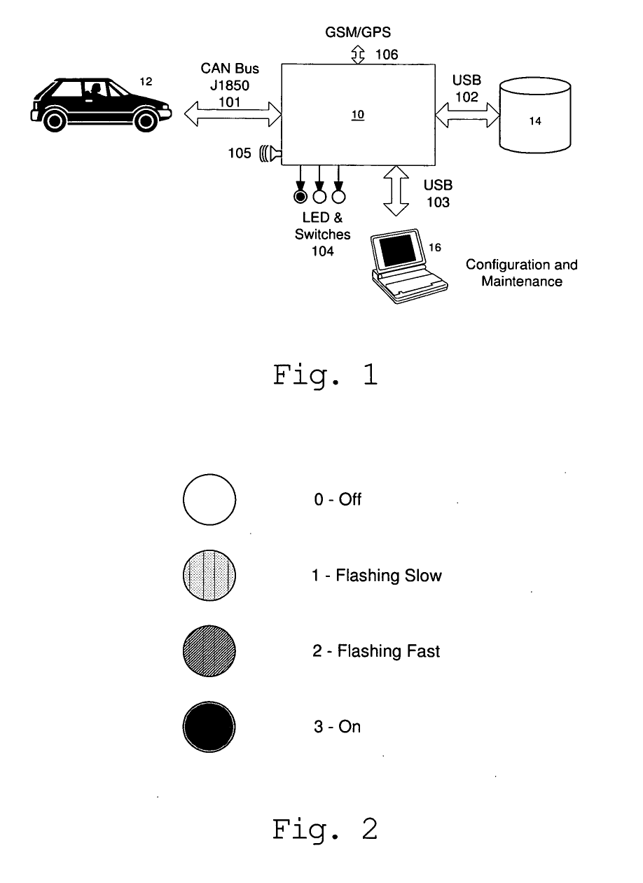

In Table I, the state ‘X’ indicates any of the four states as shown in FIG. 2, the levels N, F, I and U indicate the normal, fatal error, intermittent and correctorable condition, respectively. More specifically, in the normal (N) condition, no error and no user action is require. In the fatal error (F) condition, the device must be re-initialized by pressing the switch. In the intermittent condition (I), the display is maintained only for some time. No action is necessary. Normally, an entry is added to the system event log under such condition. In the correctable condition, the data acquisition system 10 pauses, and the user must correct the situation by pressing the switch, insert a requested device or enter a command. The error will then be removed automatically allowing the data acquisition system 10 to resume operation.

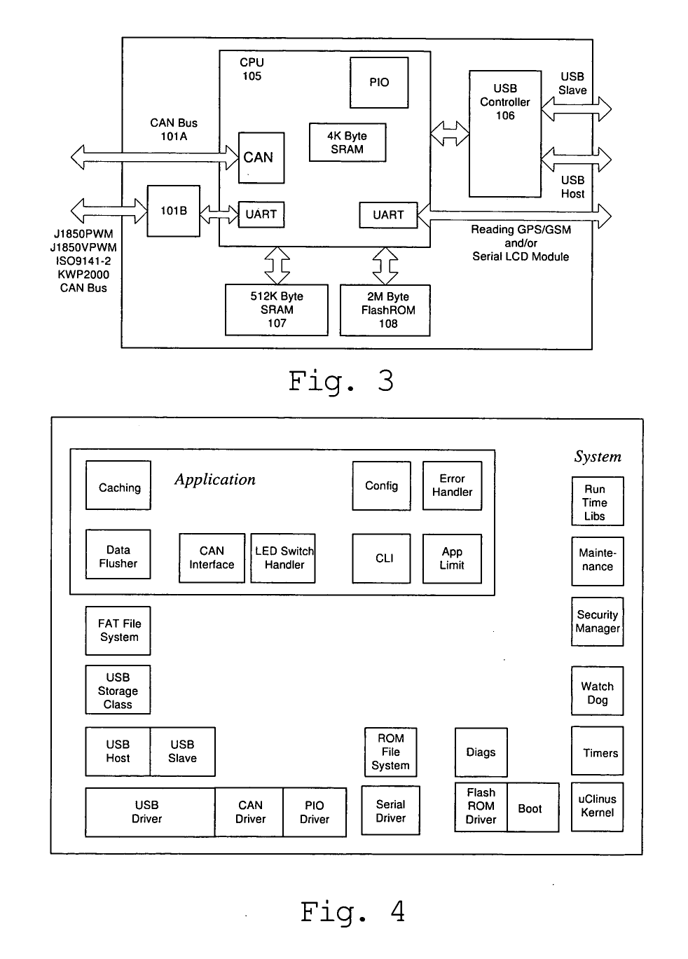

FIG. 3 is a block diagram illustrating the hardware structure of the data acquisition system 10. As shown, in addition to the connection ports 101, 102, 103 and 104, the hardware structure of the acquisition system 10 further comprises a central processing unit (CPU) 105, a USB controller 106, a static random access memory (SRAM) 107, and a read-only memory (ROM) 108, and a software embedded in the ROM 108. The circuit board of the CPU 105 also carries a built-in SRAM 151, at least one universal synchronous asynchronous receiver-transmitter (USART) 152, a programmed input/output (PIO) 153, and a controller area network (CAN) interface 154. In this embodiment, the capacities of the built-in SRAM 151, the SRAM 107, and the ROM 108 are 4K Bytes, 512K Bytes, and 4M Bytes, for example.

The software embedded in the ROM 108 is identified with a system software number in the form of a 32-bit element stored in boot configuration data (BCD) as “MMmUBBB”, where “MM” indicates the major version number, “m” indicates the minor version number, “U” indicates the update version number, and “BBBB” indicates the build number. For example, a system software number of “01120123” indicates the version 1.1.2 Build 123. Preferably, the software version number is available to the application and can be displayed in the maintenance console. As shown in FIG. 4, the software is divided into a set of system software module and an application specific module, denoted as “system software” and “application software” respectively hereinafter. The system and application software are configured by a system configuration table pre-stored in the ROM 108. The bootstrap is based on U-Boot, and the system configuration table is protected by a cyclic redundancy check (CRC) to prevent accidental alteration and is duplicated for security. The contents of the configuration table are listed in Table II.

TABLE II

| Description | Initial Value |
|---|---|
| Maintenance console settings | 9600, 8, E |
| System event log size | 64 |
| Watch Dog setup. Automatic device re- | Automatic |
| initialization of manual re-initialization. It the | |
| system becomes locked up, the internal Watch | |
| Dog is activated and can be set to automatically | |
| reinitialize the device or wait for a user | |
| interaction. | |
| User Mode Program. Defines the name of the | /u/styqs/bin/usermode |
| file in the ROM file system that contains the | |
| application code. Maintenance password | ‘maint’ |
| Halt device is system event log is full and a | FALSE |
| critical event cannot be logged | |
| Serial port usage (bootstrap of login) | Bootstrap |
| Default serial port setting | 9600, even, 8 bits |
| SRAM Size in K | 512 |

At the boot time, the data acquisition system 10 performs some minimal initial self-diagnostics (ISD), which is designed to take a very short time. ISDs failures are classified as “Severe” and “Auxiliary”. Severe errors prevent the data acquisition system 10 from starting, while auxiliary errors prevent some non-essential functions from being available. The ISDs are summarized in Table III as follows.

TABLE III

| Test | Description | Severe | Aux |
|---|---|---|---|
| CODE-CHK | Check for the Flash ROM code integrity | X | |
| SRAM-I | Internal SRAM test | X | |
| SRAM-X | External SRAM test | X | |
| CAN | CAN interface | X | |
| USB | USB interface | X | |
| TIMER | Internal timer and watch dog | X | |
| CLOCK | External time date clock | X | |
| SERIAL | Serial device | | X |

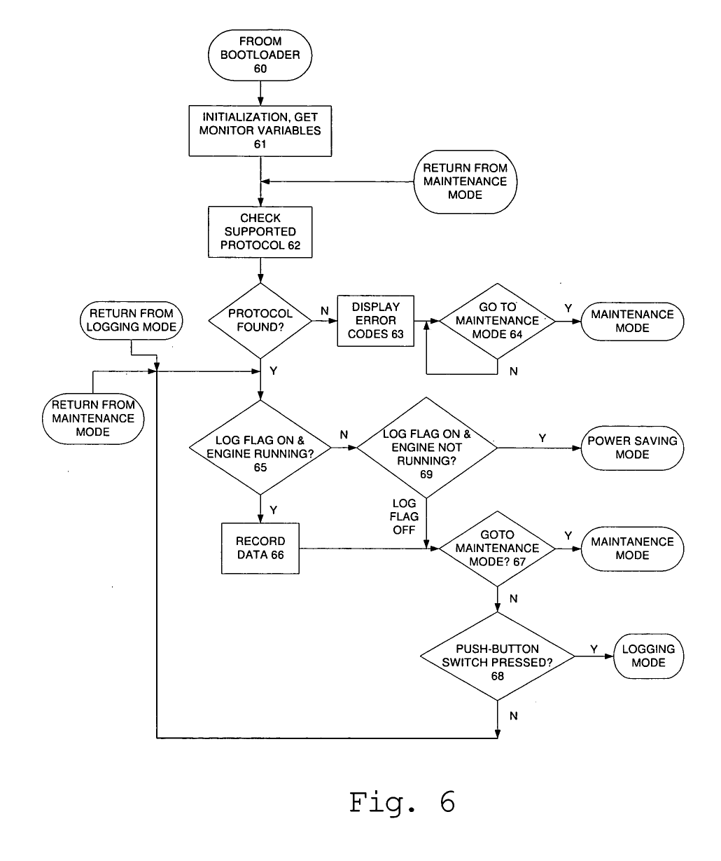

As shown in the code organization illustrated in FIG. 5, the Flash ROM 107 contains the entire code listed in Table III. At boot time, some section of the code is copied into the external SRAM 108 for performance reason. The Flash ROM 107 itself is divided into a ‘Text’ section 107A and a read-only Unix (ROM) file system 107B. The ‘test’ section 107A contains the boot code, ISDs, authentication signatures and non performance-critical code. The ROM file system 107B contains the code that must be loaded in the RAM 107, including the performance critical system code and applications. As shown, the internal SRAM 151 is normally used for code execution and contains mostly stacks and Kernel data. The internal SRAM 151 is not battery backed-up. When in maintenance mode, code can be downloaded from the external memory stick 14 or a personal computer through a cable connected to the data acquisition system 20 to SRAM 108 for execution or copied to Flash ROM 107. Code in the Flash ROM 107 or external memory stick 14 is protected by a checksum for integrity and authenticated. The watchdog periodically checks the code in ROM 107 and RAM 108 to prevent tampering. The repartition of the code between RAM 108 and ROM 107 is dictated by space and performance constraints and may change between releases.

Referring further to FIG. 4, the system software includes a plurality of drivers for interfacing the data acquisition system 10 with various applications. In this embodiment, the Flash ROM driver controls the internal Flash ROM 107 (ATMEL AT49BV, for example) which is organized in 31×64K byte and 8×8 byte sectors and supports soft and hard lock protection on an individual sector basis. As described above, the Flash ROM 107 is divided into a text section 107A that contains initial code and a ROM file system 107B. When powering up, all sectors are soft locked. The content of the Flash ROM 107 can be changed by software under maintenance mode. The AT49BV contains a 128-bit protection register divided into two 64-bits sectors A and B. The sector A is used as a unique identifier and is exposed by the driver to serialize the device. The sector B is programmed with a 64-bit authentication key and locked out when the device is programmed for the first time. The key is used to authenticate software loaded in the system during production and during field upgrades. While erasing a sector, access to the Flash ROM 107 is not permitted by the driver.

The LED driver is a specific driver that allows controlling the state of LEDs as described in Table I. The read( ) and write( ) system calls are NOPs. Changing the state of one or more LEDs is performed through an ioctl( ) that provides a bit mask describing the LED and the state thereof. The switch is connected to the PIOA3 pin. While being depressed, the switch is operative to generate an interrupt. Under the maintenance mode, the switch is used exclusively by the data acquisition system 10; while under the user mode, the application must have a thread waiting on the device using a read( ) system call.

The serial driver is used for development and access to a shell. The serial port is by default under the control of the bootstrap loader. It is possible to modify the configuration to use it as a login port. Access to the serial ports is protected by a password. If under the control of the bootstrap loader, the password is specified in the configuration table. If a login is running, the password is controlled by uClinux.

The CAN driver is based on the LinCAN driver for Linux, available under the Mozila public License, which is a modified general public license (GPL). The LinCAN is a Linux kernel module that implements a CAN driver originally developed for RTLinux. It is a part of a set of CAN/CANopen related components developed as part of OCERA framework. The application programming interface (API) is defined by the OCERA framework. The implementation is a modification of the driver to use the ATMEL internal CAN controller, and an implementation of a minimal C library to emulate RTLinus services inside uCLinux.

The USB driver supports various versions of USB protocols such as USB 2.0 at both full speed (12 Mb/s) and low speed (1.5 Mb/s). The USB driver controls the TransDimension controller TD242LP and sets the one of the two ports as slave and host ports. The slave port is used to accept maintenance commands from an external host, and the host port is used to access the external memory stick. The slave USB driver implements an emulation of a serial device. The device enumerates as a communication device class (CDC) and can be used with the standard Windows USBSER.sys driver. Once connected, a Unix login is started on the device. The host driver manages the host USB port. It provides support for the FAT file system, which will be further discussed as follows.

As also shown in FIG. 4, the system software also provides several file systems, including the ROM file system and the FAT file system. The ROM file system is a version of the native Linux file system and used solely to store application files that need to be loaded dynamically. Preferably, the files in the ROM file system can be updated while maintenance mode, for on-site software upgrades. The FAT file system is used to store data on the removable memory stick, and to allow loading software upgrade. Typically, the FAT file system is operative to recognize memory stick specially formatted by a proprietary utility which creates a normal FAT table, allocates a sector at a calculated address, removing such sector from the available space, and stores encrypted information in the sector. When the removable memory stick is inserted in the USB port of the data acquisition system 10, the driver calculates the location of the sector, accesses it and decodes the encrypted information. In addition to the removable memory stick, the files in the ROM file system can also be updated through a personal computer through a USB port or a serial cable. Depending on the content of the encrypted data block, the memory stick is recognized as one of the following types:

DATA: Suitable to record sampled data;

MAINTENANCE: Contains a script that contains maintenance commands (like loading a new version of the software).

If this operation is not successfully or the type of the memory stick 14 is not recognized, the memory stick 14 is used in read-only mode. When a unique Vender Id/Product Id is available to identify the removable memory stick 14, this software protection will be removed. In addition, since the FAT host driver is based on open source software, the modified driver must be made publicly available. The protection is to ensure that only a certain device is used to write sampled data, the security module is coded as an external component that is not subject to the GPL licensing agreement.

The text section 107A of the Flash ROM 107 is protected by a checksum to ensure that is not altered. Individual files in the ROM File system are protected by individual checksums. The configuration data contains information critical to the operation of the data acquisition system 10. The configuration data is stored in the SRAM 151. To prevent damage to the table during a main power failure or accidental alteration, the table is duplicated and each copy is protected by a checksum. More specifically, when a parameter is updated in a table, not only this table is updated, applied with a newer version number, and check-summed to be validated, the other table is then updated with the same version number, check-summed to be valid also. The dual table operation mode guarantees that the system is never without a valid configuration table, even if the system halts while updating a table, as the previous version of the table is kept enact as long as the update is not complete and validated by a checksum. If the configuration is found corrupted, a critical event entry is logged in the system event log and the other table is used. It is possible that the system being halted while updating the system configuration, the remaining table does not have the new configuration. If both configuration tables are found corrupted, a status is displayed on the LED as listed on table I, and the system is halted until the user re-initializes the device.

The SRAM application data must be protected by the application itself. The internal watchdog is programmed to detect software lockup. The application must regularly access the watchdog to inform the system that the application is responding normally. In case of deadlock, the device can be configured to either restart automatically (software RESET) or enter a locked state waiting for a user interaction. The default is to reset automatically.

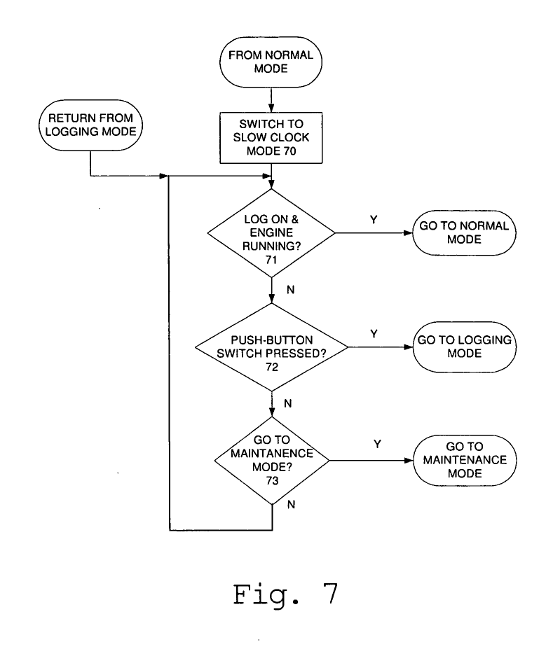

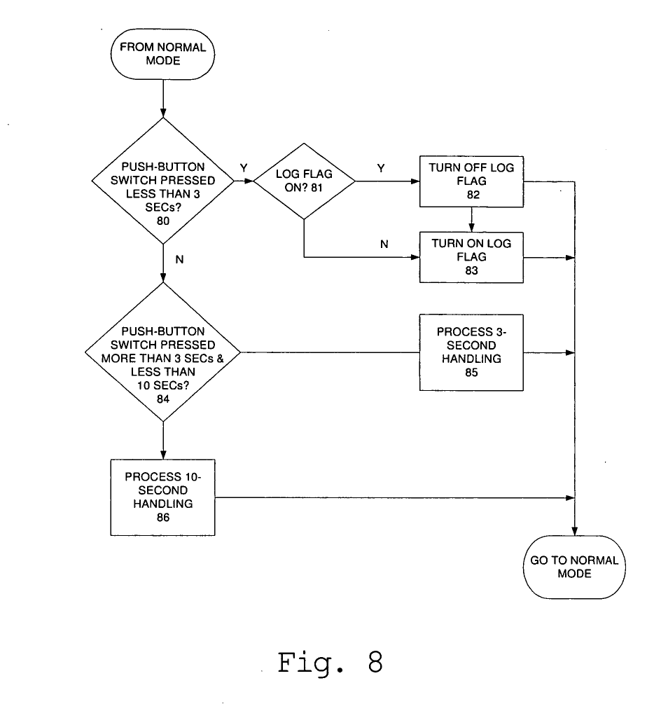

The data acquisition system 10 as discussed above can be operated under a normal operation mode, a maintenance mode, a power saving mode, and a logging mode. After the system 10 is initialized, it automatically enters user mode by loading and running program specified in the configuration table. When in maintenance mode, data sampling continues normally. However, depending on the maintenance operation being performed, sampling performance may degrade. FIG. 6 shows the process flow of the system 10 under the normal operation mode, FIG. 7 shows the process flow of the power saving mode, and FIG. 8 shows the process flow of the logging mode.

As shown in FIG. 6, while being booted by the boot loader 60, the system 10 is initialized to check the stored variables, so as to determine which parameters to monitor in step 61. The system 10 is then ready to start interface with the vehicle through the ODB connection in step 61. In step 62, the protocol, such as ISO9141, J1850 VPW, J1850 PWM, CAN, that the vehicle is used is determined. If no protocol is found, as illustrated in step 63, an error is declared through the blinking of the LEDs, followed by a step 64 to determine whether to enter maintenance mode or not. If the protocol is found and the communication between the system 10 and the vehicle is established, whether the vehicle is running and the logging flag is on are determined in step 65. If the vehicle is running and the logging flag is on, the data is recorded and stored into the USB device as required by the parameters in step 66. After recording the data, if a request of maintenance operation is found in step 67, the system 10 enters the maintenance mode. If no request of maintenance is found in step 67, whether the push-button switch is pressed is determined in step 68. If the switch is depressed, the system 10 enters the logging mode; otherwise, the process returns to the step 65 of checking the status of the logging flag and the operation condition of the engine. If it is determined that the engine is not running in step 65, whether the logging flag is on is determined in step 68. If the logging flag is found off in step 68, whether the system 10 is to enter the maintenance mode is determined in step 69. If the maintenance mode is not requested in step 69, depending on the depression condition of the push-button switch, the system 10 enter the logging mode or returning step 65 to check the logging flag and engine running status.

When the vehicle (engine) is in an idle mode, that is, when the engine is not running and when the logging flag is not switched on, the saving mode is entered, and the system is switched into a slow clock mode in order to reduce power consumption. The process flow of the power saving mode is illustrated in FIG. 7. As shown, the process starts with switching the system 10 to a slow clock mode in step 70. In the slow clock mode, the system 10 is operative to monitor the activities of the engine at a slower pace. Under the slow clock mode, the running condition of the engine is detected in step 71: Once the engine is found to be running, the system 10 will return to the normal operation mode. Otherwise, the status of the push-button switch 104 is checked in step 72. Once being depressed, the system 10 enters the logging mode. If it is found that the push-button switch is not depressed in step 72, whether to enter the maintenance mode is determined in step 73. If no request of entering the maintenance mode can be found in step 73, the system returns to the step of checking the running condition of the engine in step 72.

When the push-button switch 104 is pressed, the amount of time that the push-button switch remains pressed will determine the logging mode that the system 10 will undertake. In step 80, whether the push-button switch 104 has been pressed less than 3 seconds is determined. If the depression of the push-button switch 104 is found to last less then 3 seconds, whether the logging flag is on is determined in step 81, followed by the steps 82 and 83 of turning off and on the logging flag respectively when the logging flag us found on and off in step 81. Once the logging flag is switched on or off in steps 82 and 83, the system 10 is ready to returns to normal mode. If the push-button switch 104 is depressed for more than 3 seconds, whether the depression lasts for less than 10 seconds is determined in step 84. For depression held less than 10 seconds, the 3-second handling is processed in step 85; and for depression held longer than 10 seconds, the 10-second handling is processed in step 86. After the 3-second and 10-second handlings, the system 10 returns to the normal operation mode again.

Under the logging mode, the recording of the data from the vehicle will be toggled from on to off or from off to on depending on the previous state thereof if the switch 104 is pressed momentarily. If the recording is off and no file is open in the USB memory stick 14, the recording will be turned on when the switch 104 is pressed. The ASA device will open a new file in the USB and all the data will be recorded in the new file. The name of the file is preferably based on the VIN and the time stamp. If the recording was off and a file is already open, any new data will be stored under the same file the next time the switch 104 is pressed to enable recording.

During the 3 second handling, that is, when the switch 104 is pressed and held for 3 to 10 seconds, the system 10 will close any file open in the USB device 14 and open a new file with a file name composed of the VIN of the vehicle and the new time stamp. The recording mode will be turned on thereafter. The monitoring of the parameters will be based on the previously stored variables stored in the Flash memory 107 of the system 10. However, if a USB memory stick 14 is inserted into the second USB port 102 when during the process of the 3 second handling, the configuration data of the USB memory stick 14 is then read from the USB memory stick 14 instead. The new configuration data will also be stored in the Flash memory of the system 10. Once the system 10 is unplugged from the OBD port of the vehicle, the device will open a new file with the VIN and time stamp on the next plug-in. All the monitoring parameters will be read from the Flash memory 107 of the system.

If the depression of the switch lasts for more than 10 seconds, the system will force closing any open file in the USB memory stick 14 and reset all the monitoring parameters to the factory default setting. A new file will be open in the USB memory stick 14 with the name composed of the VIN of the vehicle and the new time stamp.

The maintenance mode can be entered by the actions of connecting a PC to the slave USB port or the serial port and inserting a specially formatted memory stick 14 in the host USB port. In the latter action, a shall command allows switching to the maintenance mode after logging in to uClinux. The maintenance commands accepted by the system 10 are listed in Table VI. If the request of maintenance mode is entered from the slave USB port 102, the commands are entered interactively. When the request of maintenance mode is entered by inserting a specifically formatted memory stick 14 in the host USB port 102, the commands are read and executed from a script.

TABLE VI

| Command | Description |
|---|---|
| CONFIG | Set the device configuration |
| DATE | Set the internal date |
| DIAGS | Diagnostics |
| EXIT | Exit the maintenance mode |
| LOAD | Load the internal Flash ROM |
| TIME | Set the internal time |
| RESET | Reset the device |
| SHELL | Open a Linux shell |
| SYSLOG | Manage the system event log |

When inserting an external memory stick 14 in the external device, the driver identifies the type of stick that was inserted. If the memory stick is of a type ‘MAINTENANCE’, a script instructs to the system10 to perform a software upgrade by copying the ROM image to the internal Flash ROM 107. The upgrade can consist of either the entire Flash ROM 107, only the initial text section 107A or of the ROM File system 107B. After copying the data, the system should be re-initialized. If the external memory stick 14 does not contain a configuration file, the internal configuration table is preserved; otherwise, it is overwritten. This mechanism allows upgrading software on site with limited user intervention.

The system 10 maintains a configurable system event log in SRAM 151 used for system incident logging such as power on, ISDs failures. Log entries are classified into the critical class and informational class. The critical entries are never overwritten. They must be cleared explicitly by the application. In formational entries may be overwritten if there is no space left in the log. The log is a rotating log. In other words, after logging the specified number of entries, events are overwritten as needed, except critical log entries that can only be erased by an explicit command issued from the application of the maintenance console. If the log is filed with critical entries, no more entry is permitted and an error condition is reported on the LEDs. The system can be configured to stop its operation if the system event log is full and a critical event cannot be stored. The system event log should be read by the application, stored to the external removable USB memory stick 14 to communicate important system events like a power up and cleared each time the application is started or when a device reports an error.

In one embodiment, there is no mechanism to maintain power in case the main power is suppressed. Only the SRAM 151 has a battery backup. Therefore, all data acquisition will cease when the main power fails. When the power comes back up, the system 10 will add in the SRAY system event log a power back-on entry. When the application starts up, it should validate the SRAM data cache to ensure that all transactions stored in the cache are valid. If an invalid transaction is encountered, the application should remove the corrupted data and add an entry in the system event log.

Data errors are detected by the driver and reported to the application, which must take appropriate action, depending on the severity of the error. All errors are logged in the system event log. After a fatal system error such as an ISD error, table configuration corruption, Watch Dog alert, a proper indication is displayed on the LEDs 104 and the system 14 is halted. It then optionally waits for the switch to be pressed or resets itself. This triggers a software reset and a complete re-initialization. All data except the system configuration in the SRAM 151 is lost. If the system halted in the middle of the write cycle to the external memory stick, the block of data may be corrupted. While performing the initial setup, the system 10 checks the system configuration tables. If both are invalid or if the software version is incompatible with the table, the software assumes this is a first boot and reset the configuration to the initial shipping state.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An automotive diagnostic and tuning system, comprising:
a first interface for connecting an on-board diagnostic port of a vehicle;
a second interface for connecting to a removable memory device; and
a firmware executed to retrieve data from the vehicle through the first interface and to record the data into the removable memory device through the second interface.

2. The automotive diagnostic and tuning system of claim 1, wherein the first interface is operative to communicate with the on-board diagnostic interface supported by at least one of pulse width modulation protocol, VPW protocol, ISO9141-2 protocol, ISO 14230 KWP2000 protocol, and ISO 15765 CAN protocol.

3. The automotive diagnostic and tuning system of claim 1, wherein the second interface includes a USB interface.

4. The automotive diagnostic and tuning system of claim 1, wherein the USB interface provides a host USB port and a slave USB port.

5. The automotive diagnostic and tuning system of claim 1, further comprising a third interface for connecting a computer.

6. The automotive diagnostic and tuning system of claim 5, wherein the third interface includes a USB interface or a serial bus.

7. The automotive diagnostic and tuning system of claim 1, wherein the firmware includes a Flash ROM and a software pre-stored in the Flash ROM.

8. The automotive diagnostic and tuning system of claim 6, wherein the software includes an application software and a system software.

9. The automotive diagnostic and tuning system of claim 7, wherein the application software does not fall into public domain and the system software makes use at least one public domain components covered by General Public License.

10. The automotive diagnostic and tuning system of claim 7, wherein the system software provides a plurality of drivers to interface the vehicle, the computer and the removable memory device and a plurality of internal devices.

11. The automotive diagnostic and tuning system of claim 7, wherein the Flash ROM further includes a configuration table pre-stored therein.

12. The automotive diagnostic and tuning system of claim 8, further comprising a CPU, an external SRAM, and an internal SRAM.

13. The automotive diagnostic and tuning system of claim 1, further comprising a plurality of light-emitting diodes each being operative to emit light in a plurality of patterns.

14. The automotive diagnostic and tuning system of claim 13, wherein combinations of the light patterns emitted by the light-emitting diodes indicate predefined operation conditions.

15. The automotive diagnostic and tuning system of claim 1, further comprising at least one switch operative to generate interrupt during operation.

16. The automotive diagnostic and tuning system of claim 1, further comprising a serial output port for outputting data to a GSM device, a GSM and GPS combined device, or a LCD module.

17. The automotive diagnostic and tuning system of claim 1, wherein the removable memory device includes a pre-store application program allowing the data recorded therein to be directly accessed.

18. A programmable stand-alone type of automotive diagnostic and tuning system, comprising:
a first connection port operative to plug in an on-board diagnostic device of a vehicle and delivering power from the vehicle;
a second connection port allowing a removable memory device to plug in;
a set of memory devices pre-storing a software controlling operation of the system; and
a set of light-emitting diodes operative to generate a plurality of patterns to indicate a plurality of different operation conditions.

19. The system of claim 18, wherein the software pre-stored in the set of memory devices is updated when the removable memory device plugged in the second connection port contains a configuration file.

20. The system of claim 18, wherein the second connection port includes a USB port.

21. The system of claim 18, wherein the second connection port includes a host USB port and a slave USB port.

22. The system of claim 18, further comprising a switch operative to switch operation into a logging mode while being pressed.

23. The system of claim 18, further comprising a third connection port for connecting a computer for maintenance.

24. The system of claim 23, wherein the third connection port includes a USB port or a serial port.
